(19) United States
(12) Patent Application Publication
(10) Pub. No.: US 2023/0015874 A1
(43) Pub. Date: Jan. 19, 2023

(54) INFORMATION PROCESSING DEVICE AND INFORMATION PROCESSING METHOD

(71) Applicant: SONY GROUP CORPORATION, TOKYO (JP)

(72) Inventor: KENTARO IDA, TOKYO (JP)

(21) Appl. No.: 17/757,759

(22) PCT Filed: Dec. 14, 2020
(86) PCT No.: PCT/JP2020/046457

§ 371 Date: Jun. 20, 2022

(30) Foreign Application Priority Data
Dec. 27, 2019 (JP) 2019-237874

(51) Int. Cl. G01B 11/02; G01B 11/26; G03B 21/14

(52) U.S. Cl. CPC G01B 11/026; G01B 11/26; G03B 21/145

(57) ABSTRACT

The present technology relates to an information processing device and an information processing method capable of implementing video projection using a plurality of projection devices more reliably. There is provided an information processing device including a control unit configured to detect a manipulation of a user on a designator projected to a projection area of each of a plurality of projection devices and generate relative position information regarding relative positions of the plurality of projection areas based on a detection result. The present technology can be applied to, for example, a device controlling a plurality of projectors.

### TECHNICAL FIELD

The present technology relates to an information processing device and an information processing method, and more particularly to, an information processing device and an information processing method capable of implementing video projection using a plurality of projection devices more reliably.

### BACKGROUND ART

In recent years, to implement broader projection mapping or high-resolution video projection, schemes of ensuring resolutions or areas by arranging a plurality of projectors in a tile form have been adopted.

When video projection is performed using a plurality of projectors, calibration is necessary in advance. As such a type of calibration scheme, a technology for calibrating a camera detection position and a trajectory display position of a pen type device in advance with respect to each projector and a camera set was disclosed (for example, see PTL 1).

### CITATION LIST

### Patent Literature

### [PTL 1]

JP 2015-191484A

### SUMMARY

### Technical Problem

However, in the technologies of the related art including the technology disclosed in PTL 1, some content of a projected video cannot be handled and real-time cannot be guaranteed at the time of inputting with a pen type device. Therefore, the technology does not suffice as a calibration scheme.

Therefore, a technology for implementing video projection using a plurality of projection devices more reliably is required.

The present technology has been devised in view of such circumstances and enables implementation of video projection using a plurality of projection devices more reliably.

### Solution to Problem

An information processing device according to an aspect of the present technology is an information processing device including a control unit configured to detect a manipulation of a user on a designator projected to a projection area of each of a plurality of projection devices and generate relative position information regarding relative positions of the plurality of projection areas based on a detection result.

An information processing method according to another aspect of the present technology is an information processing method of causing an information processing device to detect a manipulation of a user on a designator projected to a projection area of each of a plurality of projection devices and generate relative position information regarding relative positions of the plurality of projection areas based on a detection result.

In the information processing device and the information processing method according to still another aspect of the present technology, a manipulation of a user on a designator projected to a projection area of each of a plurality of projection devices is detected and relative position information regarding relative positions of the plurality of projection areas is generated based on a detection result.

The information processing device according to an aspect of the present technology may be an independent device or an internal block included in one device.

### BRIEF DESCRIPTION OF DRAWINGS

FIG. 1 is a diagram illustrating an exemplary configuration of a projection system of an embodiment to which the present technology is applied.

FIG. 2 is a diagram illustrating examples of patterns of combinations of two screens in accordance with projection areas.

FIG. 3 is a diagram illustrating an example of geometric correction on projection areas.

FIG. 4 is a diagram illustrating an example of homographic transformation.

FIG. 5 is a diagram illustrating an example of transition of a projection area.

FIG. 6 is a diagram illustrating an example of a pattern of a time-series in which boundary points of projection areas are detected.

FIG. 7 is a diagram illustrating an example of geometric correction on projection areas.

FIG. 8 is a diagram illustrating an example of a method of calculating a rotational angle between projection areas when the boundaries of the projection areas overlap.

FIG. 9 is a diagram illustrating an example when the boundaries of the projection areas are in contact with each other.

FIG. 10 is a diagram illustrating an example of a method of calculating a rotational angle between the projection areas when the boundaries of the projection areas are in contact with each other.

FIG. 11 is a diagram illustrating an example when the boundaries of the projection areas become separated from each other.

FIG. 12 is a diagram illustrating an example of a method of calculating a rotational angle between the projection areas when the boundaries of the projection areas become separated from each other.

FIG. 13 is a diagram illustrating an example of a method of calculating a vertical shift amount between the projection areas.

FIG. 14 is a diagram illustrating an example of a guide during calibration.

FIG. 15 is a diagram illustrating an example of a notification for prompting the geometric correction again.

FIG. 16 is a diagram illustrating an example of calibration when a drive type projector is used.

FIG. 17 is a diagram illustrating an example during collective calibration of overlapping projection areas when a drive type projector is used.

FIG. 18 is a diagram illustrating an example of an animation of a character moving over a projection area.

FIG. 19 is a diagram illustrating an example of cooperation of a drive type projector and a fixed type projector.

FIG. 20 is a diagram illustrating an example of coordinates in the boundaries of the

FIG. 21 is a diagram illustrating an example of coordinates of the projection areas in the boundaries of the projection areas.

FIG. 22 is a block diagram illustrating an exemplary configuration of each device of a projection system to which the present technology is applied.

FIG. 23 is a flowchart illustrating processing of a calibration phase.

FIG. 24 is a flowchart illustrating processing of an application phase.

FIG. 25 is a diagram illustrating an exemplary configuration of a computer.

### DESCRIPTION OF EMBODIMENTS

### <1. Overview of Present Technology>

When a video of content is projected over a plurality of projectors, the position of a top left of each projection area of each projector is the origin, that is, (x, y)=(0, 0) in a coordinate system of each projector, and a continuity of coordinates or connected coordinates are unclear in each projector.

For example, in a case in which first and second projectors are arranged side by side, it is assumed that a video of content is displayed over the two projectors. Then, if the position of the top left of a projection area of the first projector on the left side is the origin, an x coordinate returns to 0 again when the x coordinate goes over the right corner of the projection area and enter a projection area of the second projection on the right side.

To solve this problem, coordinate transformation cannot be performed unless a rotational relation between a screen and relative position coordinates between two projectors is known.

For example, as a scheme for solving this problem, a scheme of recognizing mutual projection areas through calibration using a camera that performs overall image capturing with a bird's eye view, a scheme of recognizing a continuity at a boundary surface using coordinates input by a user with a pen type device or the like at respective times, and the like have been proposed.

Specifically, the above-described PTL 1 discloses a technology related to a digital blackboard with a large screen in which a pen type device is used. First and second projectors arranged side by side and first and second cameras with an angle of field slightly broader than the projection areas of the projectors are disposed. A camera detection position (a camera coordinate system) of a pen type device and a trajectory display position (a projector coordinate system) are calibrated in advance with respect to the projectors and the set of the cameras, and thus a trajectory is displayed at a location drawn with the pen type device.

Here, when drawing is performed over projection areas (SC1 and SC2) of two projectors, there are an ending point (Pua) of a trajectory detected in one projection area (SC1) and a starting point (Pub) of a trajectory detected in the other projection area (SC2). Here, line segments from these points to the ends of the screens are interpolated ((Pua-Pus1)/(Pus2-Pub)). At this time, a reference determined as an input in which the ending point (Pua) and the starting point (Pub) are continuous is determined when two events come at one period of sampling.

In this scheme, however, it is necessary to detect screen passing-over and an input with the pen type device in a sample of one period. Therefore, for example, correspondence points cannot be detected when an animation moving independently passes over a screen.

As features of this scheme, because of an algorithm for observing a trajectory at the time of an input alike before and after screen passing-over and subsequently interpolating an area near a boundary surface, postprocessing after the input is performed. When an input of text or a figure is assumed to be performed as an input with the pen type device, real time is important. However, this scheme is a scheme in which real time properties cannot be guaranteed near a screen. Further, since calculation is performed from input coordinates at respective times, it can be expected that a load due to calculation cost would also be high. These are all a hindrance to having real time properties.

In this way, in the scheme disclosed in the above-described PTL 1, there is a problem that application to independent animation display cannot be achieved, due to an increase in the size of a system and necessity of a user input at respective times.

When it is assumed that a case in which a drive type projector driven at two axes in the horizontal and vertical directions (hereinafter referred to as a moving projector) is used, projection to any area of a space is performed in the drive type projector while changing a posture of the projector every time. Therefore, in calibration performed once with a positional relation, a projection relation between a plurality of projectors may change.

In view of such circumstances, the present technology proposes a scheme of performing geometric correction (trapezoidal correction) of each projector in a unicursal line using a pen type device and also calibrating a relative position relation between projection areas of a plurality of projectors simply as preliminary calibration processing.

In particular, when a drive type projector is used, it is not necessary to perform recalibration even after a change in a projection angle due to storing a pan angle and a tilt angle during the calibration and self-calibration in a relation between the projection areas after movement is performed through internal calculation.

Hereinafter, an embodiment of the present technology will be described with reference to the drawings. The embodiment of the present technology will be divided into two phases, a calibration phase and an application phase, and will be described in this order.

<2. Calibration Phase>

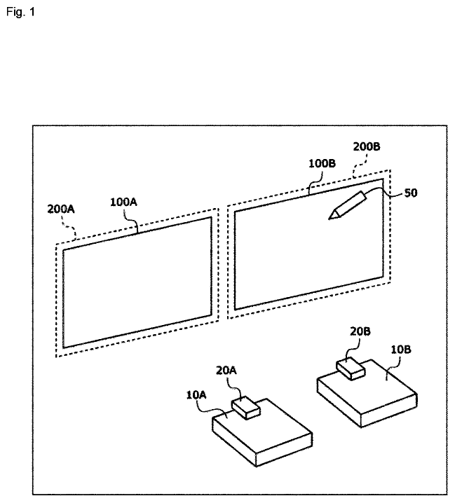

FIG. 1 is a diagram illustrating an exemplary configuration of a projection system of an embodiment to which the present technology is applied.

The projection system is a system that implements, for example, broader projection mapping or high-resolution video projection using a plurality of projection devices.

In FIG. 1, in the projection system, two projectors 10A and 10B are disposed to be adjacent to each other in the horizontal direction. A camera 20A is disposed on the upper surface of the casing of the projector 10A and a camera 20B is disposed on the upper surface of the casing of the projector 10B.

The projector 10A projects and displays a video on a projection surface based on video data input from a device such as a personal computer. In FIG. 1, an area to which the projector 10A can perform projection on a screen is illustrated as a projection area 100A. An area which can be recognized by the camera 20A is represented as an angle of camera field 200A. The angle of camera field 200A is an area slightly broader than the projection area 100A.

The projector 10B projects and displays a video on a projection surface based on video data input from a device such as a personal computer. In FIG. 1, an area to which the projector 10B can perform projection on the screen is represented as a projection area 100B and an area which can be recognized by the camera 20B is represented as an angle of camera field 200B. The angle of camera field 200B is an area slightly broader than the projection area 100B.

The pen type device 50 is held with a hand of a user and is manipulated, so that a figure such as a line can be drawn in the projection areas 100A and 100B, for example, during calibration.

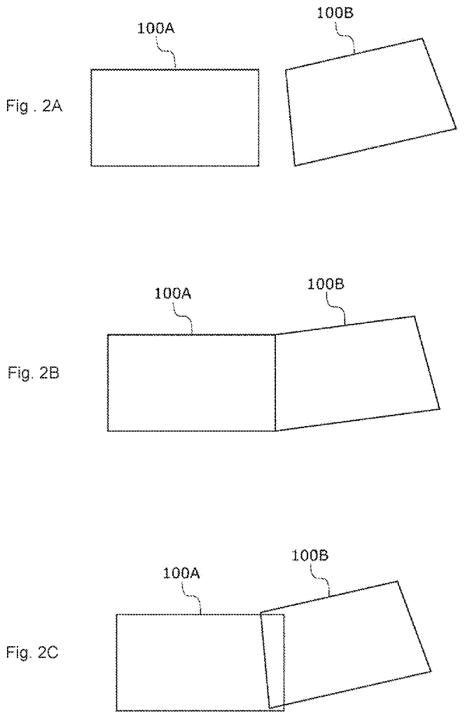

When the two projectors 10A and 10B are disposed to be adjacent to each other in the horizontal direction, for example, three patterns illustrated in FIG. 2 are assumed broadly as combinations of two screens of the projection areas 100A and 100B.

That is, a pattern (A of FIG. 2) in which the projection areas 100A and 100B are separated apart, a pattern (B of FIG. 2) in which the projection areas 100A and 100B are entirely in close contact with each other, and a pattern (C of FIG. 2) in which the projection areas 100A and 100B overlap are assumed.

Here, as illustrated in B of FIG. 2, an environment in which sides of boundaries of the projection areas are completely matched is ideal. However, actually, as illustrated in A and C of FIG. 2, a slight gap or overlapping occurs between the projection areas.

In the example of FIG. 2, since the two projectors 10A and 10B are disposed to be adjacent to each other in the horizontal direction, the projection areas 100A and 100B are arranged in the horizontal direction. However, the projection areas 100A and 100B may be located in the vertical direction or an oblique direction other than the horizontal direction.

An objective of the present technology is to set all the overlapping relations and omnidirectional disposition of the three patterns illustrated in FIG. 2 as targets and recognize relative positional relations between a plurality of projection areas during calibration.

There are two objectives in the calibration scheme to which the present technology is applied. The first objective is to perform geometric correction when projection areas become trapezoidal due to a situation such as oblique projection from the viewpoint of relations between the projectors and the projection surfaces. The second objective is to recognize a relative relation between projection areas of a plurality of projectors and obtain a continuity of coordinates. Hereinafter, description will be made in order in accordance with actual processing.

### (Geometric Correction of Projection Area)

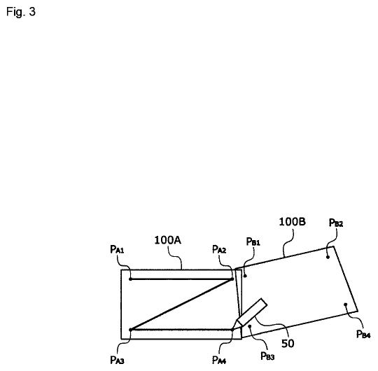

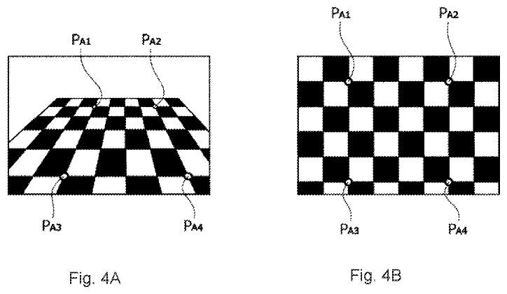

First, geometric correction of the projection area 100A will be described with reference to FIGS. 3 and 4.

As illustrated in FIG. 3, a case in which geometric correction is performed on the projection area 100A in a situation in which the projection area 100B becomes trapezoidal and partial regions of the projection areas 100A and 100B overlap is assumed.

At this time, a user sequentially connects feature points P_{A1} to P_{A4} which are four designator displayed in the projection area 100A by the projector 10A with the pen type device 50 in a unicursal line. At this time, by detecting that a pen point of the pen type device 50 which is an indicator arrives at the feature point P_{A1} based on a captured image captured by the camera 20A, it is possible to associate a position of the pen point detected in the camera coordinate system with the feature point P_{A1} displayed in the projector coordinate system.

By similarly performing this processing on the remaining three feature points P_{A2} to P_{A4} displayed in the projection area 100A, a homographic transformation matrix of the camera coordinate system and the projector coordinate system is generated.

In FIG. 3, to facilitate description, a unicursal trajectory of the user is illustrated with a bold line. However, actually, this trajectory is not displayed on the projection area 100A. Regarding the display of a trajectory on a projection area, the same applied to other drawings to be described below.

FIG. 4 illustrates an example of homographic transformation. In FIG. 4, to facilitate description, a case in which a pattern of a checker board is recognized is also illustrated. However, actually, only a pen manipulation on the feature points P_{A1} to P_{A4} is recognized.

A of FIG. 4 illustrates a captured image captured by the camera 20A. B of FIG. 4 illustrates a projected image projected by the projector 10A. That is, the captured image in A of FIG. 4 is transformed into a facing image to become the projected image in B of FIG. 4.

A homographic transformation matrix used for this transformation is generated by causing the points P_{A1} to P_{A4} on the captured image to correspond to the points P_{A1} to P_{A4} on the projected image, that is, the feature points P_{A} of a pen manipulation.

The homographic transformation matrix generated through the foregoing calibration is defined as in Expression (1) below.

xₐ′=Hₐxₐ (1)

In Expression (1), xₐ′ indicates that coordinates of the projector 10A, xₐ indicates coordinates of the camera 20A, and Hₐ indicates a homographic transformation matrix between the projector 10A and the camera 20A.

### (Transition of Projection Area)

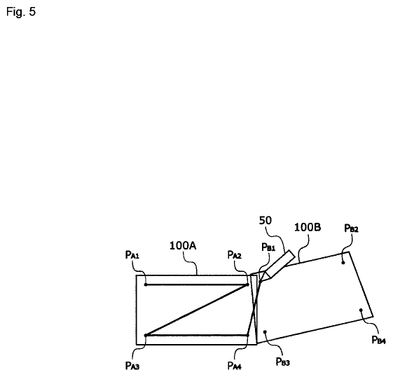

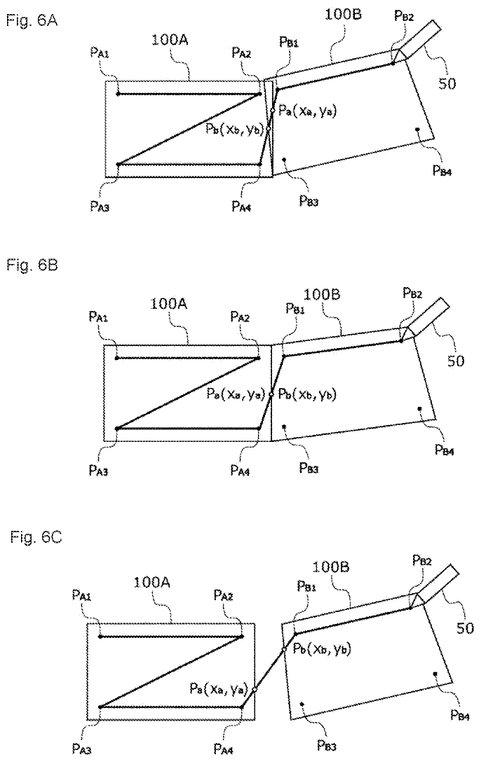

Next, transition from the projection area 100A to the projection area 100B will be described with reference to FIGS. 5 and 6.

FIG. 5 illustrates an aspect in which the four feature points P_{A1} to P_{A4} displayed in the projection area 100A are connected sequentially in a unicursal line through a pen manipulation of the user, and subsequently a straight line is further connected to a first feature point PB1 among four feature points PB1 to PB4 displayed in the projection area 100B by the projector 10B.

Partial regions of the projection areas 100A and 100B overlap. Therefore, when a straight line is drawn from the feature point P_{A4} of the projection area 100A to the feature point PB1 of the projection area 100B, coordinates detected from captured images captured by the cameras 20A and 20B are stored in the boundary surfaces of the two projection areas 100A and 100B.

At this time, when Pa(xₐ, yₐ) are boundary points coming from a range of the projection area 100A and P_{b}(xb, yb) are boundary points within a range of the projection area 100B, for example, three patterns illustrated in FIG. 6 are assumed as patterns in which the boundary points are detected from the viewpoint of the two projection areas 100A and 100B.

That is, the three patterns are a pattern (A of FIG. 6) in which a boundary surface of the projection area 100B is detected virtually first when the projection areas 100A and 100B overlap, a pattern (B of FIG. 6) in which boundary surfaces of the projection areas 100A and 100B are common when the projection areas 100A and 100B are in contact with each other, and a pattern (C of FIG. 6) in which the boundary surface of the projection area 100A is detected visually first when the projection areas 100A and 100B are separated from each other.

### (Geometric Correction of Projection Area)

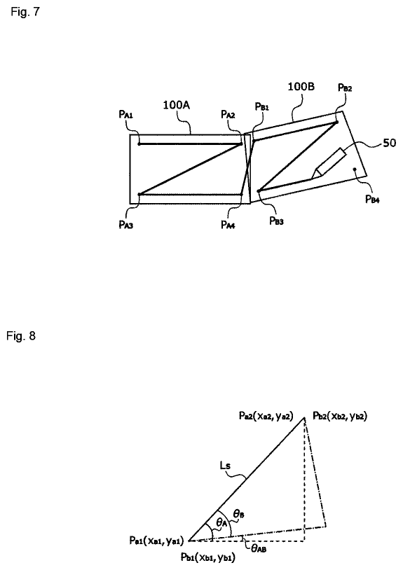

Next, geometric correction of the projection area 100B will be described with reference to FIG. 7.

FIG. 7 illustrates an aspect in which the feature point P_{A4} of the projection area 100A and the feature point PB1 of the projection area 100B are connected through a pen manipulation of the user, and subsequently the remaining three feature points PB2 to PB4 displayed in the projection area 100B are further connected sequentially in a unicursal line.

At this time, by detecting that the pen point of the pen type device 50 arrives at each of the feature points PB1 to PB4 based on a captured image captured by the camera 20B, it is possible to cause the position of the pen point detected in the camera coordinate system to correspond to the feature points PB1 to PB4 displayed in the projector coordinate system.

Thus, for the projection area 100B, a homographic transformation matrix of the camera coordinate system and the projector coordinate system is generated similarly to the above-described projection area 100A.

The homographic transformation matrix generated through the foregoing calibration is defined as in Expression (2) below.

X_{b}′=H_{b}x_{b} (2)

In Expression (2), x_{b}′ indicates coordinates of the projector 10B, x_{b} indicates coordinates of the camera 20B, and H_{b} indicates a homographic transformation matrix between the projector 10B and the camera 20B.

### (Relative Position Estimation of Projection Area)

Through the foregoing processing, the homographic transformation matrices of the projection areas 100A and 100B are obtained. Therefore, all the detected points (observation points) detected from the captured images can be transformed from the camera coordinate system to the projector coordinate system. In description of the subsequent processing, coordinates transformed to the projector coordinate system will be described as a target.

As illustrated in FIG. 6, three patterns are assumed as relative position of the projection areas from the viewpoint of the relation between the projection areas 100A and 100B. Accordingly, in description of the subsequent processing, a scheme of obtaining a relative position relation between the projection areas 100A and 100B for each pattern will be described.

(a) Case in which Two Projection Areas Overlap

As illustrated in A of FIG. 6, when at least partial areas of the projection areas 100A and 100B overlap, a boundary surface of the projection area 100B is detected temporally earlier than the boundary surface of the projection area 100A. Therefore, the boundary point transitions from P_{b} to Pₐ.

In this case, the line segments until the detection of Pₐ after the detection of P_{b} can be detected together and will be matched in the projection areas 100A and 100B.

That is, at a certain moment, coordinates of a pen point in accordance with a pen manipulation of the user in the projector coordinate system obtained by transforming a captured image captured by the camera 20A using a homographic transformation matrix Ha and coordinates in the projector coordinate system obtained by transforming a captured image captured by the camera 20B using a homographic transformation matrix Hb are matched in a space.

A rotational angle between the projection areas 100A and 100B can be calculated using the shared line segments.

FIG. 8 is a diagram illustrating an example of a method of calculating a rotational angle between the projection areas 100A and 100B when the two projection areas 100A and 100B overlap.

In FIG. 8, a straight line interposed between Pₐ₁(xₐ₁, yₐ₁) and Pₐ₂(xₐ₂, yₐ₂) which are points in the range of the projection area 100A and a straight line interposed between P_{b1}(x_{b1}, y_{b1}) and P_{b2}(x_{b2}, y_{b2}) which are points in the range of the projection area 100B are matched as a line segment Lₛ indicated by a solid line in the drawing in the space of the projector coordinate system of the projection areas 100A and 100B.

That is, the line segment Lₛ indicated by the solid line is a line segment shared between the projection areas 100A and 100B. Here, Pₐ₂(xₐ₂, yₐ₂) is a boundary point among points in the range of the projection area 100A and, P_{b1}(x_{b1}, y_{b1}) is a boundary point among points in the range of the projection area 100B.

In FIG. 8, to calculate an angle of the line segment Lₛ in the projection area 100A by applying a trigonometric function, a triangle including two sides indicated by dashed lines in the drawing in accordance with the coordinate system is used in addition to the line segment Lₛ. To calculate an angle of the line segment Lₛ in the projection area 100B by applying a trigonometric function, a triangle including two sides indicated by one-dot chain lines in the drawing in accordance with the coordinate system is used in addition to the line segment Lₛ.

An angle θ_{A} of the line segment Lₛ in the projection area 100A is calculated with Expression (3) below.

θ_{A}=tan⁻¹(yₐ₂−yₐ₁/xₐ₂−xₐ₁) (3)

An angle θ_{B} of the line segment Lₛ in the projection area 100B is calculated with Expression (4) below.

θ_{B}=tan⁻¹(y_{b2}−y_{b1}/x_{b2}−x_{b1}) (4)

A rotational angle θ_{AB} between the projection areas 100A and 100B is calculated with Expression (5) below using Expressions (3) and (4).

θ_{AB}=θ_{B}−θ_{A} (5)

In this case, a shift amount in the vertical direction (the up and down directions) (hereinafter referred to as a vertical shift amount Δy) between the projection areas 100A and 100B is calculated with a difference of the y coordinate at a correspondence point of the line segment Lₛ shared between the projection areas, that is, Expression (6) or (7) below.

Δy=yₐ₁−y_{b1} (6)

Δy=yₐ₂−y_{b2} (7)

(b) Case in which Two Projection Areas Come into Contact Each Other

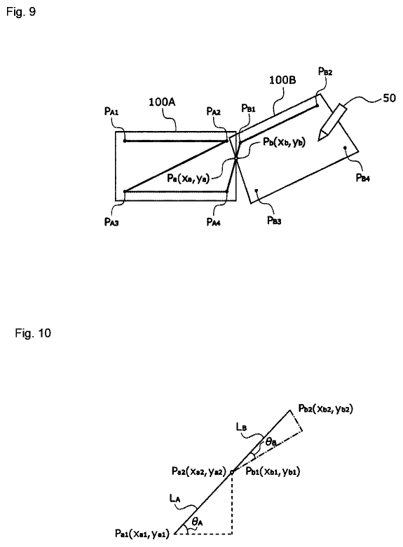

As illustrated in B of FIG. 6, when the projection areas 100A and 100B are in close contact with each other, the boundary surfaces of the projection areas 100A and 100B are common. Therefore, the boundary points are in contact with each other as Pₐ=P_{b}. At this time, as illustrated in FIG. 9, at least one of the projection areas is rotated about the boundary point in some cases. In the example of FIG. 9, the projection area 100B is rotated about the boundary point P_{b}.

In this case, by obtaining an angle from each line segment using points before and after the boundary points at both the boundary point Pₐ of the projection area 100A and the boundary point P_{b} of the projection area 100B, it is possible to calculate a rotational angle between the projection areas 100A and 100B.

FIG. 10 is a diagram illustrating an example of a method of calculating a rotational angle between the projection areas when the boundaries of the two projection areas 100A and 100B are in contact with each other.

In FIG. 10, to calculate an angle of a line segment L_{A} interposed between Pₐ₂(xₐ₂, yₐ₂) which is a boundary point of the projection area 100A and Pₐ₁(xₐ₁, yₐ₁) which is a point before the boundary point by applying a trigonometric function, a triangle including two sides indicated by dashed lines in the drawing in accordance with the coordinate system is used in addition to the line segment L_{A}.

In FIG. 10, to calculate an angle of a line segment L_{B} interposed between P_{b1}(x_{b1}, y_{b1}) which is a boundary point of the projection area 100B and P_{b2}(x_{b2}, y_{b2}) which is a point after the boundary point by applying a trigonometric function, a triangle including two sides indicated by one-dot chain lines in the drawing in accordance with the coordinate system is used in addition to the line segment L_{B}.

Here, in FIG. 10, Pₐ₂(xₐ₂, yₐ₂)=P_{b1}(x_{b1}, y_{b1}) is satisfied.

An angle θ_{A} of the line segment L_{A} in the projection area 100A is calculated with Expression (8) below.

θ_{A}=tan⁻¹(yₐ₂−yₐ₁/xₐ₂−xₐ₁) (8)

An angle θ_{B} of the line segment L_{B} in the projection area 100B is calculated with Expression (9) below.

θ_{B}=tan⁻¹(y_{b2}−y_{b1}/x_{b2}−x_{b1}) (9)

A rotational angle θ_{AB} between the projection areas 100A and 100B us calculated with Expression (10) below using Expressions (8) and (9).

θ_{AB}=θ_{B}−θ_{A} (10)

In this case, a vertical shift amount Δy between the projection areas 100A and 100B is calculated with a difference between the y coordinate of the boundary point Pₐ of the projection area 100A and the y coordinate of the boundary point P_{b} of the projection area 100B, that is, Expression (11) below.

Δy=yₐ₂−y_{b1} (11)

As will be described in detail below, when the drive type projector 10 is used, an offset amount in accordance with a change in a tilt angle may be added in Expression (11) by storing information regarding a pan angle and a tilt angle during calibration.

(c) Case in which Two Projection Areas Become Separated from Each Other

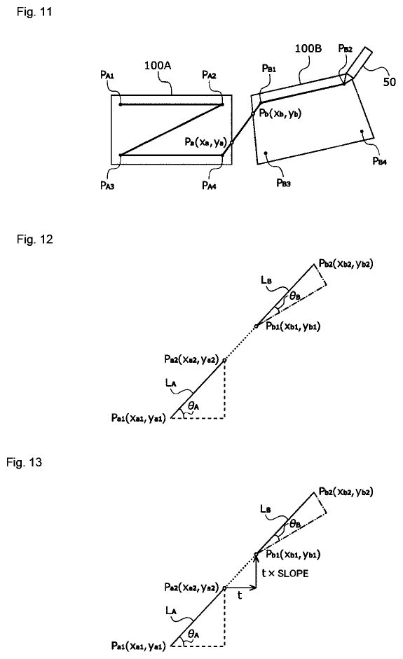

As illustrated in C of FIG. 6, when the projection areas 100A and 100B are separate, a line segment Pₐ-P_{b} of the boundary point Pₐ of the projection area 100A and the boundary point P_{b} of the projection area 100B is outside of the range of the projection area 100 and the angle of camera field 200 (see FIG. 11).

In this case, by obtaining an angle from each line segment using points before and after the boundary points at both the boundary point Pₐ in the projection area 100A and the boundary point P_{b} in the projection area 100B, it is possible to calculate a rotational angle between the projection areas 100A and 100B.

FIG. 12 is a diagram illustrating an example of a method of calculating a rotational angle between the projection areas 100A and 100B when the boundaries of the two projection areas 100A and 100B become separated from each other.

In FIG. 12, to calculate an angle of a line segment L_{A} interposed between Pₐ₂(xₐ₂, yₐ₂) which is a boundary point of the projection area 100A and Pₐ₁(xₐ₁, yₐ₁) which is a point before the boundary point by applying a trigonometric function, a triangle including two sides indicated by dashed lines in the drawing in accordance with the coordinate system is used in addition to the line segment L_{A}.

In FIG. 12, to calculate an angle of a line segment L_{B} interposed between P_{b1}(x_{b1}, y_{b1}) which is a boundary point of the projection area 100B and P_{b2}(x_{b2}, y_{b2}) which is a point after the boundary point by applying a trigonometric function, a triangle including two sides indicated by one-dot chain lines in the drawing in accordance with the coordinate system is used in addition to the line segment L_{B}.

An angle θ_{A} of the line segment L_{A} in the projection area 100A is calculated with Expression (12) below.

θ_{A}=tan⁻¹(yₐ₂−yₐ₁/xₐ₂−xₐ₁) (12)

An angle θ_{B} of the line segment L_{B} in the projection area 100B is calculated with Expression (13) below.

θ_{B}=tan⁻¹(y_{b2}−y_{b1}/x_{b2}−x_{b1}) (13)

A rotational angle θ_{AB} between the projection areas 100A and 100B is calculated with Expression (14) below using Expressions (12) and (13).

θ_{AB}=θ_{B}−θ_{A} (14)

In this case, a vertical shift amount Δy between the projection areas 100A and 100B is calculated using a relation illustrated in FIG. 13.

That is, the vertical shift amount is calculated as a result obtained by adding a difference between the y coordinate of the boundary point Pₐ of the projection area 100A and the y coordinate of the boundary point P_{b} of the projection area 100B and a value obtained by multiplying a time t between the projection areas by a slope a of the line segment Pa-P_{b}, that is, with Expression (15) below.

Δy=(yₐ₂−y_{b1})+(t×a) (15)

Through the foregoing processing, in the calibration phase, the relative position relation between the projection areas is obtained in accordance with a relative disposition pattern of the projection areas 100A and 100B, and relative position information regarding the relative position between the projection areas is stored. The relative position information is used in an application phase to be described below.

### (Modified Examples)

Here, derived processing and a graphical user interface (GUI) which can be suggested to the projection area 100 in the above-described calibration processing will be described.

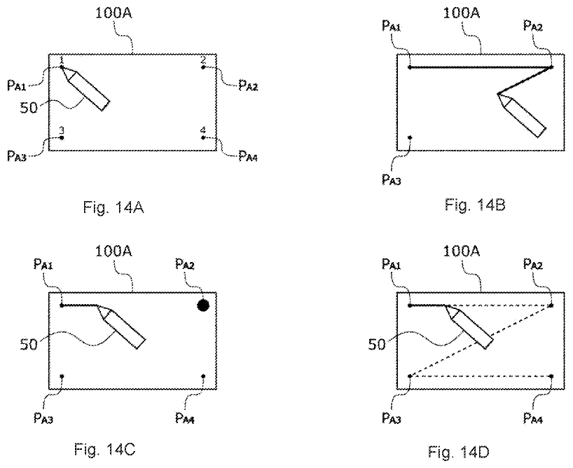

When a user draws a unicursal line using the pen type device 50, a suggested scheme with a simplest GUI is a scheme of drawing feature points P_{A} and P_{B} in the projection areas 100A and 100B. FIG. 14 is a diagram illustrating an example of a guide as support information during calibration.

In A of FIG. 14, numbers indicating a tracing sequence of feature points through a pen manipulation of a user are suggested near the feature points P_{A1} to P_{A4} in the projection area 100A. Thus, the user can draw a unicursal line tracing the feature points P_{A1} to P_{A4} in the sequence reliably while checking the numbers.

In B of FIG. 14, when a pen manipulation is performed from the feature points P_{A1} to P_{A2} in the projection area 100A, an animation in accordance with a pen manipulation on the feature point PA3 which is a subsequent target is suggested. Thus, the user can check the animation and continue to draw the unicursal line toward the feature point which is a subsequent target reliably.

In C of FIG. 14, the feature point P_{A2} which is a subsequent target of the feature point P_{A1} in the projection area 100A is emphasized and suggested. Here, as an emphasis scheme, a feature point which is a subsequent target can be expanded and displayed or displayed with different color. Thus, the user can reliably ascertain the feature point which is a subsequent target and perform a pen manipulation.

In D of FIG. 14, a guide of a line segment indicating a tracing sequence of the feature points through a pen manipulation of the user in the projection area 100A is suggested with a type of line such as a dotted line or a dashed line. Thus, the user can draw a unicursal line tracing the feature points P_{A1} to P_{A4} in the sequence reliably while checking the guide.

When transition to the geometric correction of the adjacent projection area 100B is performed despite a failure of the geometric correction of the projection area 100A because of some reasons, the user may be prompted to return to the projection area 100A and perform the pen manipulation to retry the geometric correction after the end of the geometric correction of the projection area 100B.

Even though the recognition of the relative position relation between the projection areas fails, processing for retrying the recognition of the relative position relation may be performed similarly.

In this case, a GUI may be suggested, for example, as illustrated in FIG. 15, to prompt processing for retrying the geometric correction of the projection area 100A. In the example of FIG. 15, the feature point P_{A1} of the projection area 100A flickers and is displayed. Therefore, the user can become aware of resuming the unicursal line from the feature point P_{A1} during the pen manipulation in the projection area 100B.

As described above, the fixed type projector has been mainly described. However, a drive type projector (a moving projector) may be used in the projection system to which the present technology is applied.

When a drive type projector is used, specific processing is performed, and thus the following two added values are assumed.

The first added value is omission of the sequence of the re-calibration. That is, when a homographic transformation matrix of a projection area is obtained, a pan angle and a tilt angle at that time point are stored. Thus, even in a location to which the projection area is moved after driving of the drive type projector, a relative position relation between a plurality of projection areas can be obtained through calculation.

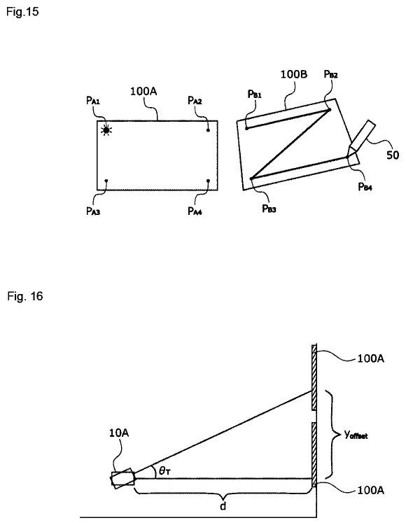

In this scheme, as illustrated in FIG. 16, a distance d between the drive type projector 10A and the projection area A can be measured and an offset amount (offset) of the y coordinate can be calculated from a change in a tilt angle θ_{T} using the value of the distance d. Thus, the sequence of the re-calibration can be skipped.

The offset amount y_{offset} of the y coordinate is calculated with, for example, Expression (16) below.

y_{offset}=d×tan θ_{T} (16)

The second added value is simplicity of the calibration processing. That is, by setting the plurality of projection areas at the same location using the drive type projector, it is possible to perform calibration of all the projection surfaces through a pen manipulation performed once by the user.

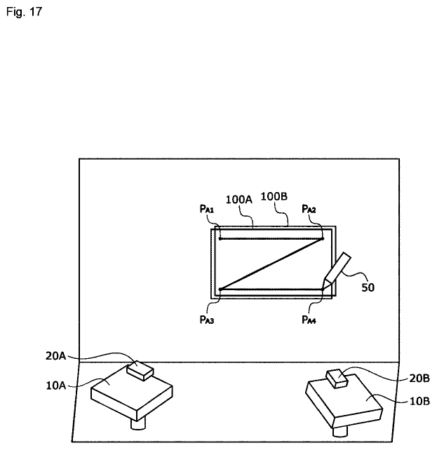

In this scheme, as illustrated in FIG. 17, the entire projection surfaces of the projection areas 100A and 100B by the projectors 10A and 10B serving as the moving projectors are set to overlap during the calibration processing.

Thus, the user can also draw the feature points in a unicursal line in the overlapping projection area 100B by connecting the feature points P_{A1} to P_{A4} displayed in the projection area 100A in a unicursal line. Thus, since the calibration of all the projection surfaces can be performed through the pen manipulation performed once, the user may not perform the pen manipulation on each projection surface, and thus a labor for the calibration can be omitted.

The calibration phase has been described above.

<3. Application Phase>

In the application phase, the relative position relation between the plurality of projection areas can be solved using the relative position information generated in the calibration phase when the projectors project and display videos to the projection areas.

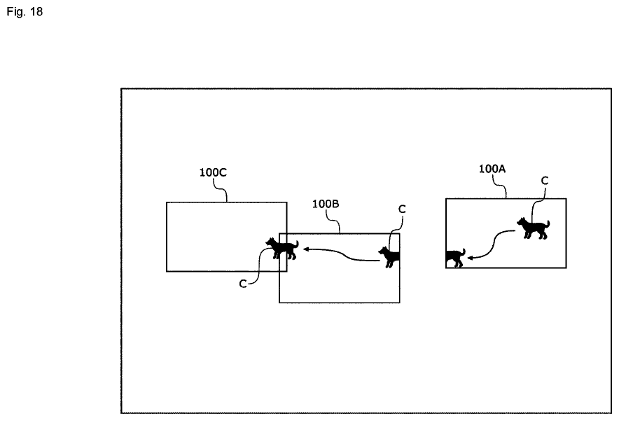

For example, FIG. 18 illustrates an animation of a character moving over the projection areas 100A to 100C using three projectors 10A to 10C.

Specifically, in FIG. 18, the projection areas 100A and 100B are in a separate state. The projection areas 100B and 100C are in a state in which partial regions overlap.

In the states, when a character C moves from the right to the left along a path indicated by an arrow in the drawing in the order of the projection areas 100A, 100B, and 100C, the character C making independent animation display can move and pass over the projection areas by using the relative position information.

Writing can also be performed using an input of the pen type device 50 or the like. In this case, in the projection system, real-time processing including detection at the time of passing over the boundaries of the projection areas is not necessary and the relative position relation is recognized in advance in the calibration phase. Therefore, the projection areas can be used as if an input is performed on one large canvas.

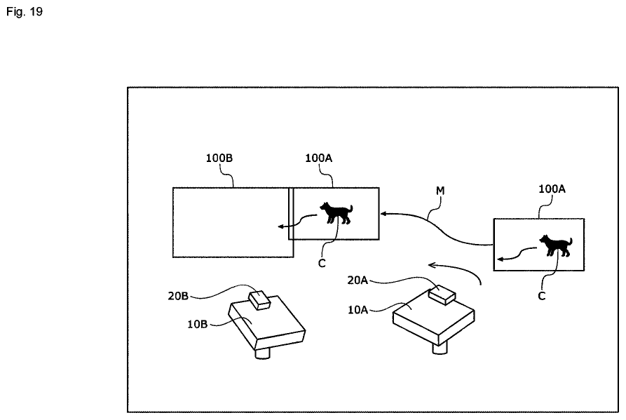

FIG. 19 illustrates an animation of a character moving between the projection areas using the drive type projector 10A and the fixed type projector 10B.

Specifically, when the character C moves from the right to the left along a path indicated by an arrow in the drawing in the order of the projection areas 100A and 100B in FIG. 19, the drive type projector 10A is driven so that the projection area 100A is moved from a position distant from the projection area 100B to a position overlapping the projection area B (as indicated by an arrow M in the drawing).

Even in this state, by storing a pan angle and a tilt angle of the projector 10A during calibration, it is possible to exchange the character C making the independent animation display from the projection area 100A to the projection area 100B using the relative position information, and thus it is possible to perform movement over the projection areas.

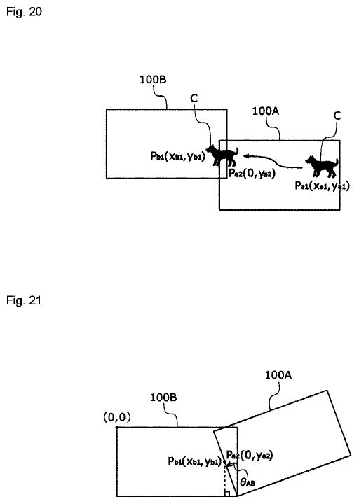

Here, as specific processing in the boundaries of the projection areas 100A and 100B, processing is performed using the relation between the projection areas 100A and 100B, as illustrated in FIG. 20, using the relative position information generated in the calibration phase. The relative position information include a rotational angle θ_{AB} between the projection areas and the vertical shift amount Δy between the projection areas.

FIG. 20 illustrates an example of coordinates in the boundaries of the projection areas when the character C moves over the projection areas in a state in which the partial regions of the projection areas 100A and 100B overlap.

In the projection area 100A, the character C is moving from the right to the left along a path indicated by an arrow in the drawing and is moving from Pₐ₁(xₐ₁, yₐ₁) to Pₐ₂(0, yₐ₂). Here, the position at the top left of a coordinate system (screen coordinates) of the projection area 100A is the origin.

At this time, since the projection areas 100A and 100B are in the overlapping state, Pₐ₂(0, yₐ₂) on the projection area 100A can be expressed at P_{b1}(x_{b1}, y_{b1}) on the projection area 100B. Pₐ₂(0, yₐ₂) and P_{b1}(x_{b1}, y_{b1}) in the boundaries of the projection areas 100A and 100B have a relation illustrated in FIG. 21.

In FIG. 21, the coordinates of P_{b1}(x_{b1}, y_{b1}) are calculated with Expressions (17) and (18) below by applying a trigonometric function related to a line segment and an angle including the boundary surfaces of the projection areas 100A and 100B using the rotational angle θ_{AB} and the vertical shift amount Δy included in the relative position information.

x_{b1}=x_{bmax}−cos(90−θ_{AB})/(yₐₘₐₓ−yₐ₂) (17)

y_{b1}=yₐ₂+y_{bmax}−sin(90−θ_{AB})/(yₐₘₐₓ−yₐ₂)+Δy (18)

Here, when the above-described calculation is performed, the position at the top left is the origin and a maximum value in the y axis direction is yₐₘₐₓ in the coordinate system of the projection area 100A. In the coordinate system of the projection area 100B, the position at the top left is the origin, a maximum value in the x axis direction is x_{bmax}, and a maximum value in the y axis direction is y_{bmax}.

The application phase has been described above.

### <4. System Configuration>

### (Configuration of Projection System)

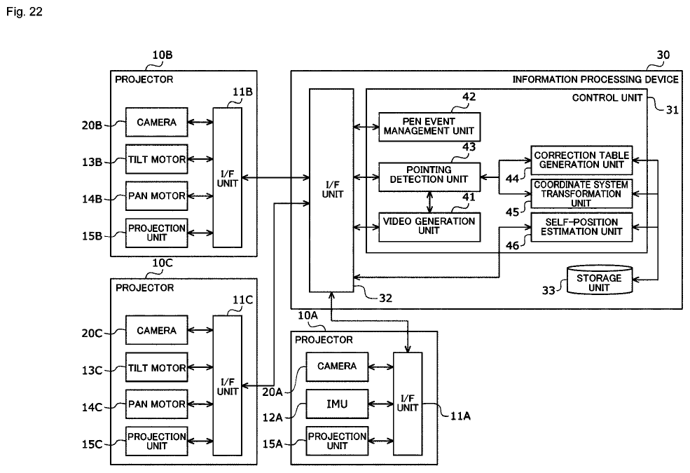

FIG. 22 is a block diagram illustrating an exemplary configuration of each device of a projection system to which the present technology is applied.

In FIG. 22, the projection system includes a plurality of projectors 10 and an information processing device 30 controlling the plurality of projectors 10.

The plurality of projectors 10 include a fixed type projector and a drive type projector. In the example of FIG. 22, the projectors 10 are configured of a total of three projectors 10, one fixed type projector 10A and two drive type projectors 10B and 10C.

The projector 10A is a fixed type projector and includes an I/F unit 11A, an IMU 12A, a projection unit 15A, and a camera 20A.

The I/F unit 11A is an interface with the information processing device 30 and is configured with a communication module, an input/output termina, or the like.

The I/F unit 11A outputs sensor data input from the IMU 12A and captured image data input from the camera 20A to the information processing device 30.

The I/F unit 11A outputs a control signal input from the information processing device 30 to the IMU 12A, the projection unit 15A, and the camera 20A. The I/F unit 11A outputs video data input from the information processing device 30 to the projection unit 15A.

The IMU 12A is an inertial measurement unit (IMU). The IMU 12A detects and outputs a 3-dimensional angular velocity and an acceleration detected by a triaxial gyroscope and a 3-way accelerometer as sensor data.

The projection unit 15A includes an optical member such as a light source or a lens and various mechanisms The projection unit 15A projects and displays a video in accordance with the video data input to the projection unit 15A to a screen or the like.

The camera 20A includes an image sensor and a signal processing unit. The camera 20A accepts light from a subject, performs photoelectric conversion, performs signal processing on an electrical signal obtained as a result, and outputs the processed electrical signal as captured image data. The camera 20A may be provided inside the projector 10A or may be provided outside.

The projector 10B is a drive type projector and includes an I/F unit 11B, a tilt motor 13B, a pan motor 14B, a projection unit 15B, and a camera 20B.

The I/F unit 11B is an interface with the information processing device 30 and is configured with a communication module, an input/output terminal, or the like.

The I/F unit 11B outputs angle data input from the tilt motor 13B and the pan motor 14B and captured image data input from the camera 20B to the information processing device 30.

The I/F unit 11B outputs control signals input from the information processing device 30 to the tilt motor 13B, the pan motor 14B, the projection unit 15B, and the camera 20B. The I/F unit 11B outputs the video data input from the information processing device 30 to the projection unit 15B.

The tilt motor 13B is a motor that drives the projector 10B in the vertical direction. The tilt motor 13B outputs angle data related to a tilt angle in accordance with the driving.

The pan motor 14B is a motor that drives the projector 10B in the horizontal direction. The pan motor 14B outputs angle data related to a pan angle in accordance with the driving.

The projection unit 15B and the camera 20B have configurations similar to the above-described projection unit 15A and camera 20A, and thus description thereof will be described.

The projector 10C is a drive type projector and includes an I/F unit 11C, a tilt motor 13C, a pan motor 14C, a projection unit 15C, and a camera 20C.

The I/F unit 11C is an interface with the information processing device 30 and is configured with a communication module, an input/output terminal, or the like.

The I/F unit 11C outputs angle data (including a tilt angle and a pan angle) input from the tilt motor 13C and the pan motor 14C and captured image data input from the camera 20C to the information processing device 30.

The I/F unit 11C outputs control signals input from the information processing device 30 to the tilt motor 13C, the pan motor 14C, the projection unit 15C, and the camera 20C.

The tilt motor 13C, the pan motor 14C, the projection unit 15C, and the camera 20C have configurations similar to the above-described tilt motor 13B, pan motor 14B, projection unit 15B, and camera 20B, and thus description thereof will be described.

The information processing device 30 is configured as a personal computer, a dedicated device, or the like. The information processing device 30 includes a control unit 31, an I/F unit 32, and a storage unit 33.

The control unit 31 is a central control device (a processing device) that performs control of an operation of each unit or various kinds of calculation processing. The control unit 31 is configured with a processor such as a central processing unit (CPU).

The I/F unit 32 is an interface with the projectors 10A to 10C and is configured with a communication module, an input/output terminal, or the like.

The I/F unit 32 outputs a control signal or video data input from the control unit 31 to the projectors 10A to 10C. The I/F unit 32 outputs data such as sensor data, captured image data, and angle data input from the projectors 10A to 10C to the control unit 31.

The storage unit 33 is an auxiliary storage device such as a semiconductor memory or a hard disk drive (HDD) and is configured as an internal storage or an external storage.

The storage unit 33 stores various kinds of data under the control of the control unit 31. The control unit 31 reads and processes various kinds of data stored in the storage unit 33.

The control unit 31 includes a video generation unit 41, a pen event management unit 42, a pointing detection unit 43, a correction table generation unit 44, a coordinate system transformation unit 45, and a self-position estimation unit 46.

The video generation unit 41 generates video data and supplies the video data to the I/F unit 32 The video data includes data related to a video which is projected to the projection areas by the projectors 10A to 10C.

The pen event management unit 42 manages an event related to the pen type device 50 manipulated with a hand of a user.

The pointing detection unit 43 detects a position on the projection area based on data such as captured image data input to the pointing detection unit 43 and supplies the detection result to the correction table generation unit 44 and the coordinate system transformation unit 45.

The correction table generation unit 44 generates a correction table storing the relative position information based on the detection result supplied from the pointing detection unit 43 or various kinds of data stored in the storage unit 33. The correction table is stored in the storage unit 33.

The coordinate system transformation unit 45 generates homographic transformation matrices of the camera coordinate system and the projector coordinate system based on the detection result supplied from the pointing detection unit 43 and the various kinds of data stored in the storage unit 33. The homographic transformation matrices are stored in the storage unit 33.

The pointing detection unit 43 may supply the detection result to the video generation unit 41 and the video generation unit 41 may perform processing related to a video in accordance with the detection result.

The self-position estimation unit 46 estimates positions, postures, and the like of the drive type projectors 10B and 10C based on data such as angle data input to the self-position estimation unit 46. Information (information regarding a tilt angle and a pan angle) regarding the estimation of the position and the like is stored in the correction table stored in the storage unit 33.

The control unit 31 performs control such that coordinates of the projection areas of the plurality of projectors 10 are transformed using the relative position information or the like stored in the correction table read from the storage unit 33 and videos are projected to the projection areas using the transformed coordinates.

In the example of FIG. 22, the case in which one fixed type projector 10A and two drive type projectors 10B and 10C are configured has been described, but the number of projectors or a ratio of the fixed type projectors to the drive type projectors are arbitrary. The projection system may be configured with only one type projector among the fixed type and drive type projectors 10.

Video data of a video projected by each of the projectors 10A to 10C is not limited to the video data input via the information processing device 30. For example, video data input directly to each processor or input via another device may be input.

### (Flow of Processing of Calibration Phase)

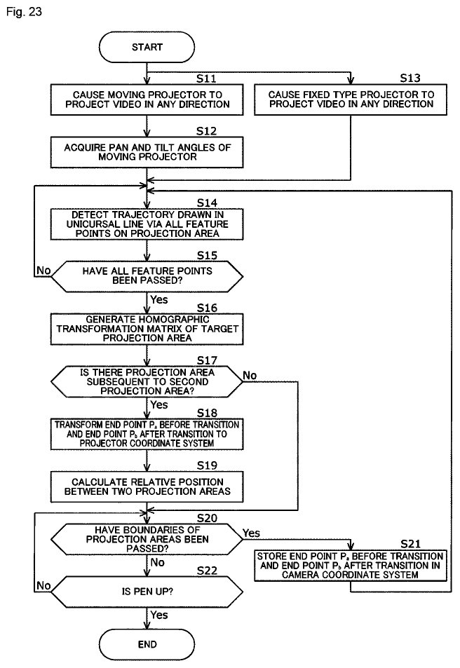

FIG. 23 is a flowchart illustrating processing of the calibration phase.

The processing is performed by the control unit 31 of the information processing device 30 during calibration when the fixed type projector 10A, the drive type projector 10B, and the like are provided as the plurality of projectors 10 included in the projection system.

The control unit 31 causes the drive type projector 10B serving as a moving projector to project a video in any direction and acquires a pan angle and a tilt angle (S11 and S12). The control unit 31 causes the fixed type projector 10A to project a video in any direction (S13).

Thus, the feature point P_{A} is displayed in the projection area 100A and the feature point P_{B} is displayed in the projection area 100B on the screen. When the processing of steps S12 and S13 ends, the processing proceeds to step S14.

The control unit 31 detects a trajectory drawn in a unicursal line via all the feature points P (P_{A1} to P_{A4}) on the manipulation target projection area through a pen manipulation of the user based on the captured image data (S14). The control unit 31 determines whether all the feature points P (P_{A1} to P_{A4}) on the manipulation target projection area have been passed based on a detection result of the trajectory (S15).

When it is determined in the determination processing of step S15 that all the feature points P on the manipulation projection target projection area 100 have been passed, the processing proceeds to step S16. The control unit 31 generates a homographic transformation matrix of the manipulation target projection area based on the detection result of the manipulation target projection area (S16).

The control unit 31 determines whether the manipulation target projection area is a projection area subsequent to the second projection area (S17). When it is determined in the determination processing of step S17 that the manipulation target projection area is not the projection area subsequent to the second projection area, that is, the first projection area (for example, the projection area 100A), the processing of steps S18 and S19 is skipped.

Conversely, when it is determined in the determination processing of step S17 that the manipulation target projection area is the projection area subsequent to the second projection area (for example, the projection area 100B), the process proceeds to step S18.

The control unit 31 transforms, for example, the end point Pₐ which is a boundary point of the projection area 100 before the transition and an end point P_{b} serving as a boundary point of the projection area 100B after the transition from the camera coordinate system to the projector coordinate system using the homographic transformation matrix of the manipulation target projection area (S18).

The control unit 31 calculates relative positions between two projection areas 100A and 100B using the end point Pₐ before the transition and the end point P_{b} after the transition transformed to the projector coordinate system (S19). The relative positions calculated here are stored as the relative position information (θ_{AB}, Δy) in the storage unit 33.

For example, as described with reference to FIGS. 2 to 13, the projection areas 100A and 100B enter one of the state in which at least partial regions overlap, the state in which the boundaries are in contact with, and the state in which the projection areas are separate. Therefore, in the calculation method in accordance with the three states, the relative position information (θ_{AB}, Δy) is calculated and stored in the correction table stored in the storage unit 33.

When the processing of step S19 ends, the processing proceeds to step S20. The control unit 31 determines whether the boundaries of the projection areas such as the boundaries of the projection areas 100A and 100B have been passed based on the detection result of the trajectory (S20).

When it is determined in the determination processing of step S20 that the boundaries of the projection areas have been passed, the processing proceeds to step S21. For example, the control unit 31 stores the end point Pₐ of the projection area 100A before the transition and an end point P_{b} of the projection area 100B after the transition in the camera coordinate system in the storage unit 33 (S21).

Thereafter, the processing returns to step S14. When there is the projection area (for example, the projection area 100C) subsequent to the third projection area, the relative position between the projection areas (the projection areas 100B and 100C) is calculated and stored as relative position information (θ_{BC}, Δy) with regard to the projection area subsequent to the third projection area.

When it is determined in the determination processing of step S20 that the boundaries of the projection areas have not been passed, the processing proceeds to step S22. The control unit 31 determines whether the pen point of the pen type device 50 is raised from the screen based on the detection result of the trajectory (S22).

When it is determined in the determination processing of step S22 that the pen point is not raised from the screen, the processing returns to step S20 and the above-described processing is repeated. Conversely, when it is determined in the determination processing of step S22 that the pen point is up from the screen, the processing ends.

The flow of the processing of the calibration phase has been described.

### (Flow of Processing of Application Phase)

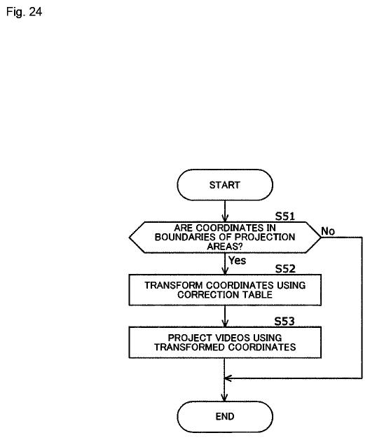

FIG. 24 is a flowchart illustrating processing of the application phase.

The processing is performed by the control unit 31 of the information processing device 30 at the time of execution of the application after completion of the calibration when the fixed type projector 10A, the drive type projector 10B, and the like are provided as the plurality of projectors 10 included in the projection system.

The control unit 31 determines whether coordinates are in the boundaries of the projection areas when videos are projected by the plurality of projectors 10 (S51).

When it is determined in the determination processing of step S51 that the coordinates are in the boundaries of the projection areas, the processing proceeds to step S52.

The control unit 31 transforms the coordinates of the boundaries of the projection areas using the relative position information (θ, Δy) or the like stored in the correction table read from the storage unit 33 (S52). The control unit 31 controls the projectors 10 such that the videos are projected to the projection areas using the transformed coordinates (S53).

For example, as described with reference to FIGS. 18 to 21, when the character C is moving through the boundaries of the projection areas 100A and 100B, the coordinates P_{b1}(x_{b1}, y_{b1}) on the projection area 100B are calculated with the above-described Expressions (17) and (18) using the relative position information (θ_{AB}, Δy) and the character C is projected based on the calculated coordinates.

When it is determined in the determination processing of step S51 that the coordinates are not in the boundaries of the projection areas, the processing of steps S52 and S53 is skipped.

The flow of the processing of the application phase has been described above.

According to the present technology, as described above, a manipulation of a user on a designator projected to a projection area of each of a plurality of projection devices is detected and relative position information regarding relative positions of the plurality of projection areas is generated based on a detection result. According to the present technology, video are projected to the plurality of corresponding projection areas by the plurality of projection devices based on the relative position information.

That is, according to the present technology, the geometric correction (trapezoidal correction) of each projector is performed in a unicursal line using the pen type device and a relative position relation between projection areas of a plurality of projectors is also calibrated simply as preliminary calibration processing.

According to the present technology, it is possible to correspond to a video of a character making independent animation display and further reduce a load of calculation cost while performing an application by storing the relative position information during the calibration. Therefore, it is possible to implement the video projection using the plurality of projection devices more reliably.

In the above description, the information processing device 30 is provided in the projection system and the information processing device 30 (the control unit 31 of the information processing device 30) performs the processing of the calibration phase and the processing of the application phase, as described above. One of the plurality of projectors 10 may have functions (some or all of the functions) of the information processing device 30, and the projector 10 may perform the processing of the calibration phase and the processing of the application phase.

The number of projectors 10 performing the processing of the calibration phase and the processing of the application phase is not limited to one. The plurality of projectors 10 may perform the processing in cooperation.

In the above description, the pen manipulation performed using the pen type device 50 has been exemplified as a manipulation of the user on the feature points of the projection areas. However, the present technology is not limited to a pen manipulation. For example, a finger of the user, another instrument, or the like may be used.

In the present specification, the video data is configured from a plurality of pieces of image data. A “video” may also be read an “image.”

### <5. Configuration of Computer>

The series of steps of processing of the above-described information processing device 30 can be performed by hardware or software. When the series of steps of processing is performed by software, a program of the software is installed in a computer of each device.

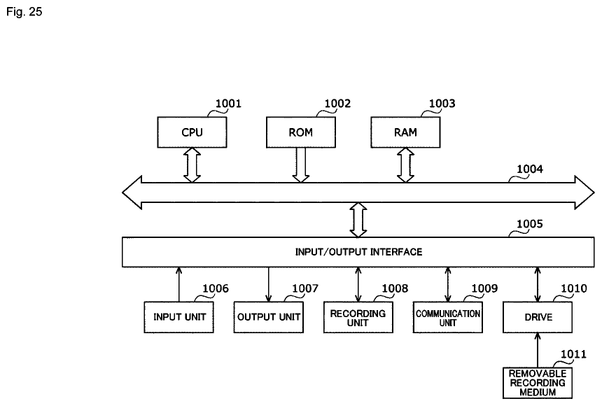

FIG. 25 is a block diagram illustrating an exemplary hardware configuration of a computer that performs the above-described series of steps of processing in accordance with a program.

In the computer, a central processing unit (CPU) 1001, a read-only memory (ROM) 1002, a random access memory (RAM) 1003 are connected to each other via a bus 1004. An input/output interface 1005 is further connected to the bus 1004. An input unit 1006, an output unit 1007, a recording unit 1008, a communication unit 1009, and a drive 1010 are connected to the input/output interface 1005.

The input unit 1006 is configured with a microphone, a keyboard, a mouse, or the like. The output unit 1007 is configured with a speaker, a display, or the like. The recording unit 1008 is configured with a hard disc, a nonvolatile memory, or the like. The communication unit 1009 is configured with a network interface or the like. The drive 1010 configures a removable recording medium 1011 such as a magnetic disk, an optical disc, a magneto-optical disc, or a semiconductor memory.

In the computer that has the foregoing configuration, the CPU 1001 performs the above-described series of steps of processing by loading a program recorded in the ROM 1002 or the recording unit 1008 in the RAM 1003 via the input/output interface 1005 and the bus 1004 and executing the program.

A program which is executed by the computer (the CPU 1001) can be recorded on, for example, the removable recording medium 1011 serving as a package medium for supply. The program can be supplied via a wired or wireless transfer medium such as a local area network, the Internet, or digital satellite broadcasting.

In the computer, a program can be installed in the recording unit 1008 via the input/output interface 1005 by mounting the drive 1010 on the removable recording medium 1011. The program can be received by the communication unit 1009 via a wired or wireless transfer medium and can be installed in the recording unit 1008. In addition, the program can be installed in advance in the ROM 1002 o the recording unit 1008.

Here, in the present specification, processing performed by the computer in accordance with the program may not necessarily be performed chronologically in the order described in the flowchart. That is, processing executed by the computer in accordance with the program also includes processing performed in parallel or individually (for example, parallel processing or processing by an object).

The program may be processed by one computer (processor) or may be distributed and processed by a plurality of computers. Further, the program may be transferred and executed by a computer located separated from each other.

Further, in the present specification, a system means a set of a plurality of constituent elements (devices, modules (components), or the like) and it does not matter whether all the constituent elements are contained in the same casing. Accordingly, a plurality of devices accommodated in separate casings and connected via a network and one device in which a plurality of modules are accommodated in one casing are all a system.

Embodiments of the present technology are not limited to the above-described embodiments and can be modified in various forms within the scope of the present technology without departing from the gist of the present technology. For example, the present technology can have a cloud computing configuration in which one function is distributed and processed in common via a network by a plurality of devices.

The steps described above in the above-described flowchart can be executed by one device and can also be distributed and performed by a plurality of devices. Further, when a plurality of steps of processing are included in one step, the plurality of steps of processing in the one step can be executed by one device and can also be distributed and performed by a plurality of devices.

The advantageous effects described in the present specification are merely exemplary and are not limited, and other advantageous effects may be achieved.

The present technology can be configured as follows.

(1) An information processing device including:
a control unit configured to detect a manipulation of a user on a designator projected to a projection area of each of a plurality of projection devices and generate relative position information regarding relative positions of the plurality of projection areas based on a detection result.

(2) The information processing device according to (1), wherein the control unit causes the plurality of projection devices to project videos to the plurality of corresponding projection areas based on the relative position information.

(3) The information processing device according to (1) or (2), wherein the relative position information includes information regarding a rotational angle between adjacent first and second projection areas and a shift amount in a vertical direction.

(4) The information processing device according to (3), wherein the first and second projection areas enter one of a state in which at least partial regions of the first and second projection areas overlap, a state in which boundaries of the first and second projection areas are in contact with each other, and a state in which the first and second projection areas are separate.

(5) The information processing device according to (4), wherein, in the state in which at least the partial regions of the first and second projection areas overlap, the control unit calculates the rotational angle and the shift amount using a line segment which is detectable together and is shared between the first and second projection areas.

(6) The information processing device according to (4), wherein, in the state in which the boundaries of the first and second projection areas are in contact with each other, the control unit calculates the rotational angle and the shift amount using points before and after points of boundaries which are detectable together in the first and second projection areas and a line segment obtained from the points.

(7) The information processing device according to (4), wherein, in the state in which the first and second projection areas are separate, the control unit calculates the rotational angle and the shift amount using points before and after points of boundaries which are detectable individually in the first and second projection areas and a line segment obtained from the points.

(8) The information processing device according to any one of (1) to (7), wherein the control unit
generates a transformation matrix in which a position of the designator projected to each projection area in a first coordinate system corresponds to a position of the manipulation of the user detected in a second coordinate system from a captured image obtained by imaging the manipulation of the user, and
transforms the position detected in the second coordinate system to the first coordinate system using the transformation matrix and generates the relative position information.

(9) The information processing device according to (8),
wherein the plurality of projection devices include a drive type projection device, and
wherein the control unit uses a pan angle and a tilt angle in the drive type projection device when the transformation matrix is generated.

(10) The information processing device according to (9), wherein the control unit acquires a distance between the drive type projection device to a projection surface, and
calculates an offset amount in a vertical direction from a change in the tilt angle using the distance.

(11) The information processing device according to (9), wherein the control unit drives the drive type projection device and sets the plurality of projection areas as the same location.

(12) The information processing device according to any one of (1) to (11), wherein the control unit suggests support information for supporting the manipulation of the user on the designator.

(13) The information processing device according to (12), wherein the support information includes information indicating a sequence of a manipulation on a designator, animation display of a manipulation target designator, emphasis display of a manipulation target designator, or guide display of a manipulation on a designator.

(14) The information processing device according to (12) or (13), wherein the support information includes information for prompting the user to perform the manipulation again with regard to a projection area in which processing for generating the relative position information fails among the plurality of projection areas.

(15) The information processing device according to any one of (12) to (14), wherein, as the manipulation of the user, the control unit detects a unicursal manipulation on the designator using an indicator.

(16) The information processing device according to (3), wherein the control unit projects the video in accordance with coordinates calculated using the rotational angle and the shift amount in boundaries of the first and second projection areas.

(17) The information processing device according to (16), wherein the video includes a video of a character making independent animation display.

(18) The information processing device according to any one of (1) to (17), wherein the plurality of projection devices include at least one type of projection device between a fixed type projection device and a drive type projection device.

(19) The information processing device according to any one of (1) to (18), wherein the information processing device is configured as one of the plurality of projection devices and an external device.

(20) An information processing method of causing an information processing device: to detect a manipulation of a user on a designator projected to a projection area of each of a plurality of projection devices and generate relative position information regarding relative positions of the plurality of projection areas based on a detection result.

### REFERENCE SIGNS LIST

10, 10A, 10B, 10C Projector

11A, 11B, 11C I/F unit

12A IMU

13B, 13C Tilt motor

14B, 14C Pan motor

15A, 15B, 15C Projection unit

20, 20A, 20B, 20C Camera

30 Information processing device

31 Control unit

32 I/F unit

33 Storage unit

41 Video generation unit

42 Pen event management unit

43 Pointing detection unit

44 Correction table generation unit

45 Coordinate system transformation unit

46 Self-position estimation unit

50 Pen type device

1. An information processing device comprising:
a control unit configured to detect a manipulation of a user on a designator projected to a projection area of each of a plurality of projection devices and generate relative position information regarding relative positions of the plurality of projection areas based on a detection result.

2. The information processing device according to claim 1, wherein the control unit causes the plurality of projection devices to project videos to the plurality of corresponding projection areas based on the relative position information.

3. The information processing device according to claim 2, wherein the relative position information includes information regarding a rotational angle between adjacent first and second projection areas and a shift amount in a vertical direction.

4. The information processing device according to claim 3, wherein the first and second projection areas enter one of a state in which at least partial regions of the first and second projection areas overlap, a state in which boundaries of the first and second projection areas are in contact with each other, and a state in which the first and second projection areas are separate.

5. The information processing device according to claim 4, wherein, in the state in which at least the partial regions of the first and second projection areas overlap, the control unit calculates the rotational angle and the shift amount using a line segment which is detectable together and is shared between the first and second projection areas.

6. The information processing device according to claim 4, wherein, in the state in which the boundaries of the first and second projection areas are in contact with each other, the control unit calculates the rotational angle and the shift amount using points before and after points of boundaries which are detectable together in the first and second projection areas and a line segment obtained from the points.

7. The information processing device according to claim 4, wherein, in the state in which the first and second projection areas are separate, the control unit calculates the rotational angle and the shift amount using points before and after points of boundaries which are detectable individually in the first and second projection areas and a line segment obtained from the points.

8. The information processing device according to claim 1, wherein the control unit generates a transformation matrix in which a position of the designator projected to each projection area in a first coordinate system corresponds to a position of the manipulation of the user detected in a second coordinate system from a captured image obtained by imaging the manipulation of the user, and
transforms the position detected in the second coordinate system to the first coordinate system using the transformation matrix and generates the relative position information.

9. The information processing device according to claim 8,
wherein the plurality of projection devices include a drive type projection device, and
wherein the control unit uses a pan angle and a tilt angle in the drive type projection device when the transformation matrix is generated.

10. The information processing device according to claim 9, wherein the control unit acquires a distance between the drive type projection device to a projection surface, and
calculates an offset amount in a vertical direction from a change in the tilt angle using the distance.

11. The information processing device according to claim 9, wherein the control unit drives the drive type projection device and sets the plurality of projection areas as the same location.

12. The information processing device according to claim 1, wherein the control unit suggests support information for supporting the manipulation of the user on the designator.

13. The information processing device according to claim 12, wherein the support information includes information indicating a sequence of a manipulation on a designator, animation display of a manipulation target designator, emphasis display of a manipulation target designator, or guide display of a manipulation on a designator.

14. The information processing device according to claim 12, wherein the support information includes information for prompting the user to perform the manipulation again with regard to a projection area in which processing for generating the relative position information fails among the plurality of projection areas.

15. The information processing device according to claim 12, wherein, as the manipulation of the user, the control unit detects a unicursal manipulation on the designator using an indicator.

16. The information processing device according to claim 3, wherein the control unit projects the video in accordance with coordinates calculated using the rotational angle and the shift amount in boundaries of the first and second projection areas.

17. The information processing device according to claim 16, wherein the video includes a video of a character making independent animation display.

18. The information processing device according to claim 1, wherein the plurality of projection devices include at least one type of projection device between a fixed type projection device and a drive type projection device.

19. The information processing device according to claim 18, wherein the information processing device is configured as one of the plurality of projection devices and an external device.

20. An information processing method of causing an information processing device:
to detect a manipulation of a user on a designator projected to a projection area of each of a plurality of projection devices and generate relative position information regarding relative positions of the plurality of projection areas based on a detection result.
